(19) United States
(12) Patent Application Publication
(10) Pub. No.: US 2026/0339272 A1
(43) Pub. Date: Oct. 29, 2026

(54) SUCCESSIVE APPROXIMATION REGISTER TIME TO DIGITAL CONVERTER

(71) Applicant: IUCF-HYU (INDUSTRY-UNIVERSITY COOPERATION FOUNDATION HANYANG UNIVERSITY), Seoul (KR)

(72) Inventors: Jae Duk HAN, Seoul (KR); Dong Jun LEE, Seoul (KR); Yong Hwa KWON, Seoul (KR); Bon A LIM, Seoul (KR)

(21) Appl. No.: 19/646,410

(22) Filed: Apr. 13, 2026

Related U.S. Application Data
(63) Continuation of application No. PCT/KR2025/016637, filed on Oct. 20, 2025.

(30) Foreign Application Priority Data
Apr. 23, 2025 (KR) 10-2025-0053302

(51) Int. Cl. G04F 10/00

(52) U.S. Cl. CPC G04F 10/005

(57) ABSTRACT

A successive approximation register time-to-digital converter includes: a comparator configured to receive a plurality of input pulses including a first input pulse and a second input pulse and compare arrival times of the first input pulse and the second input pulse; a first multiplexer configured to receive the plurality of input pulses; a second multiplexer configured to receive the plurality of input pulses; a first delay line connected to the first multiplexer; and a second delay line connected to the second multiplexer.

### CROSS-REFERENCE TO RELATED APPLICATION

This application is a bypass continuation of pending PCT International Application No. PCT/KR2025/016637, which was filed on Oct. 20, 2025, and which claims priority from Korean Patent Application No. 10-2025-0053302, filed on Apr. 23, 2025, the disclosure of which is incorporated herein by reference in its entirety.

### BACKGROUND

### 1. Field of the Invention

The present disclosure relates to a successive approximation register time-to-digital converter and, more particularly, to a successive approximation register time-to-digital converter in which a plurality of input pulses are first applied to multiplexers before delay lines so that fewer delay lines are used than in the prior art, thereby enabling errors in delays of the plurality of input pulses to be more easily calibrated.

### 2. Discussion of Related Art

As the information society has advanced, various types of electronic devices, such as smartphones, tablets, and notebook computers, have evolved beyond miniaturization into wearable devices.

At the same time, demand has greatly increased for high performance, such as high-speed communication and high resolution, as well as for low power consumption and small area in such electronic devices.

As a solution thereto, instead of a conventional scheme in which information is carried in voltage and acquired by an analog-to-digital converter (ADC), a method has begun to be used in which information is acquired using a time-to-digital converter (TDC) that utilizes time information. Such a time-to-digital converter (TDC) is a circuit that measures a time difference between a plurality of input pulses and converts the same into a digital code.

In particular, among such time-to-digital converters (TDCs), a successive approximation register (SAR) time-to-digital converter (TDC) is one of the most commonly used TDC architectures.

In a SAR TDC according to the prior art, a plurality of delay lines are used, and when a delayed start signal arrives later than a reference signal, the SAR TDC operates by outputting a digital code corresponding to the delay time between the start signal and the reference signal. Accordingly, the prior-art SAR TDC suffers from high power consumption.

In addition, because errors caused by mismatches among the plurality of delay lines are difficult to calibrate, there is a disadvantage in that the operating speed of the overall circuit is reduced.

### SUMMARY

Accordingly, a successive approximation register time-to-digital converter according to one embodiment of the present disclosure has been made to solve the foregoing problems and is characterized, more particularly, in that a multiplexer (MUX) receives an input pulse before a delay line. As a result, fewer delay lines are used than in the prior art, whereby errors in the delay lines may be reduced.

Further, because fewer delay lines are used, power used for circuit operation may be reduced.

Further, in the successive approximation register time-to-digital converter according to one embodiment of the present disclosure, an output of a comparator is used as a selection signal of a multiplexer (MUX), so that an output of the comparator and an output of the multiplexer (MUX) are matched, thereby suppressing data distortion caused by a mismatch between the comparator output and the multiplexer (MUX) output.

A successive approximation register time-to-digital converter according to one embodiment of the present disclosure may include: a comparator configured to receive a plurality of input pulses including a first input pulse and a second input pulse and compare arrival times of the first input pulse and the second input pulse; a first multiplexer configured to receive the plurality of input pulses; a second multiplexer configured to receive the plurality of input pulses; a first delay line connected to the first multiplexer; and a second delay line connected to the second multiplexer.

The first multiplexer and the second multiplexer may determine, based on a comparison result of the comparator, to which one of the first delay line and the second delay line the first input pulse and the second input pulse are to be transmitted.

The first multiplexer may determine that an input pulse having an earlier arrival time among the first input pulse and the second input pulse is transmitted to the first delay line.

The second multiplexer may determine that an input pulse having a later arrival time among the first input pulse and the second input pulse is transmitted to the second delay line.

The first delay line may hold an input pulse input to the first delay line until one of the plurality of input pulses is input to the second delay line.

The second delay line may simultaneously output an output signal of the second delay line in synchronization with an output signal of the first delay line.

The successive approximation register time-to-digital converter may further include a comparator delay line configured to receive the plurality of input pulses and hold the plurality of input pulses for an operating time of the comparator.

The comparator delay line may include a third delay line configured to receive the first input pulse and transmit the received first input pulse to one of the first multiplexer and the second multiplexer.

The comparator delay line may include a fourth delay line configured to receive the second input pulse and transmit the received second input pulse to one of the first multiplexer and the second multiplexer.

A successive approximation register time-to-digital converter according to another embodiment of the present disclosure may include: a comparator configured to receive a plurality of input pulses including a first input pulse and a second input pulse and compare arrival times of the first input pulse and the second input pulse; a first multiplexer configured to receive the plurality of input pulses; a second multiplexer configured to receive the plurality of input pulses; a first delay line connected to the first multiplexer; a second delay line connected to the second multiplexer; and a comparator delay line configured to receive the plurality of input pulses and hold the plurality of input pulses for an operating time of the comparator.

The first multiplexer may determine that an input pulse having an earlier arrival time among the first input pulse and the second input pulse is transmitted to the first delay line.

The second multiplexer may determine that a pulse having a later arrival time among the plurality of input pulses is transmitted to the second delay line.

The first delay line may hold an input pulse input to the first delay line until one of the plurality of input pulses is input to the second delay line.

The second delay line may simultaneously output an output signal of the second delay line in synchronization with an output signal of the first delay line.

According to still another embodiment of the present disclosure, in a successive approximation register time-to-digital converter including a plurality of data bit lines, each of the plurality of data bit lines may include: a comparator configured to receive a plurality of input pulses including a first input pulse and a second input pulse and compare arrival times of the first input pulse and the second input pulse; a first multiplexer configured to receive the plurality of input pulses; a second multiplexer configured to receive the plurality of input pulses; a first delay line connected to the first multiplexer; and a second delay line connected to the second multiplexer.

### Advantageous Effects

Accordingly, in the successive approximation register time-to-digital converter according to one embodiment of the present disclosure, because a multiplexer (MUX) receives an input pulse before a delay line, fewer delay lines are used and errors occurring in the delay lines can be reduced.

Further, because fewer delay lines are used, power consumption can be reduced.

Further, in the successive approximation register time-to-digital converter according to one embodiment of the present disclosure, an output of the comparator and an output of the multiplexer (MUX) are matched, so that data distortion caused by an output mismatch can be suppressed.

### BRIEF DESCRIPTION OF THE DRAWINGS

FIG. 1 is a diagram illustrating a SAR TDC circuit according to the prior art.

FIG. 2 is a diagram illustrating a SAR TDC circuit according to the prior art, which is an improvement over FIG. 1.

FIG. 3 is a diagram illustrating a SAR TDC circuit according to an embodiment of the present disclosure.

FIG. 4 is a diagram illustrating an operation of the SAR TDC circuit according to an embodiment of the present disclosure when an INP pulse arrives first.

FIG. 5 is a diagram illustrating a simulation result of the operation of FIG. 4.

FIG. 6 is a diagram illustrating an operation of the SAR TDC circuit according to an embodiment of the present disclosure when an INN pulse arrives first.

FIG. 7 is a diagram illustrating a simulation result of the operation of FIG. 6.

FIG. 8 is a diagram illustrating a SAR TDC circuit composed of a plurality of bits according to an embodiment of the present disclosure.

FIG. 9 is a diagram illustrating a simulation result of the operation of FIG. 8.

### DETAILED DESCRIPTION OF EXEMPLARY EMBODIMENTS

The embodiments described in the present specification and the configurations shown in the drawings are merely preferred examples of the present disclosure, and various modifications may be made thereto that can replace the embodiments and drawings of the present specification at the time of filing of the present application.

In addition, like reference numerals or symbols in the drawings of the present specification denote parts or elements that perform substantially the same function.

Further, terms used in the present specification are used to describe embodiments and are not intended to limit and/or restrict the present disclosure. A singular expression includes a plural expression unless the context clearly indicates otherwise.

As used herein, terms such as “include” or “have” are intended to specify the presence of stated features, numerals, steps, operations, elements, parts, or combinations thereof recited in the specification, and do not preclude the possibility of the presence or addition of one or more other features, numerals, steps, operations, elements, parts, or combinations thereof.

Further, ordinal terms such as “first” and “second” may be used to describe various elements, but such elements should not be limited by those terms. Such terms are used only for the purpose of distinguishing one element from another.

For example, without departing from the scope of the present disclosure, a first element may be referred to as a second element, and similarly a second element may be referred to as a first element. The term “and/or” includes any and all combinations of one or more of the associated listed items.

Hereinafter, embodiments according to the present disclosure will be described in detail with reference to the accompanying drawings.

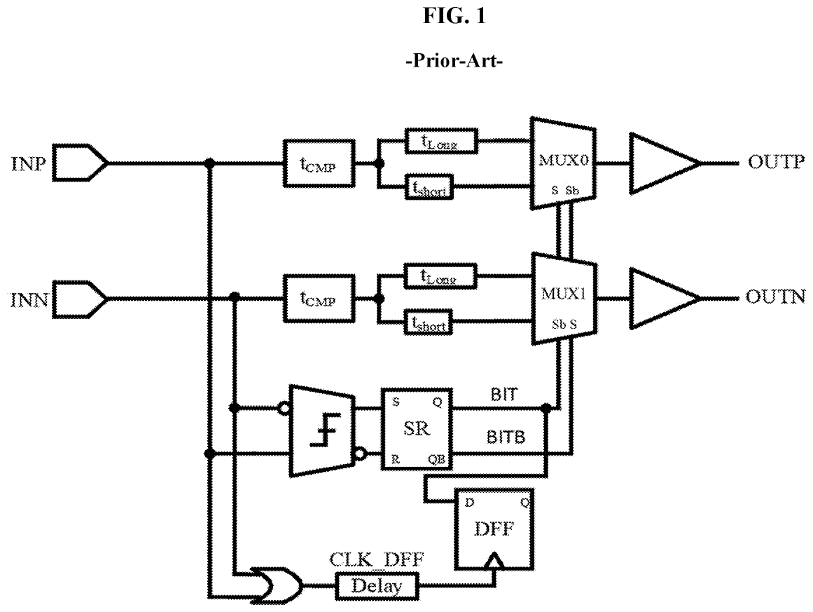

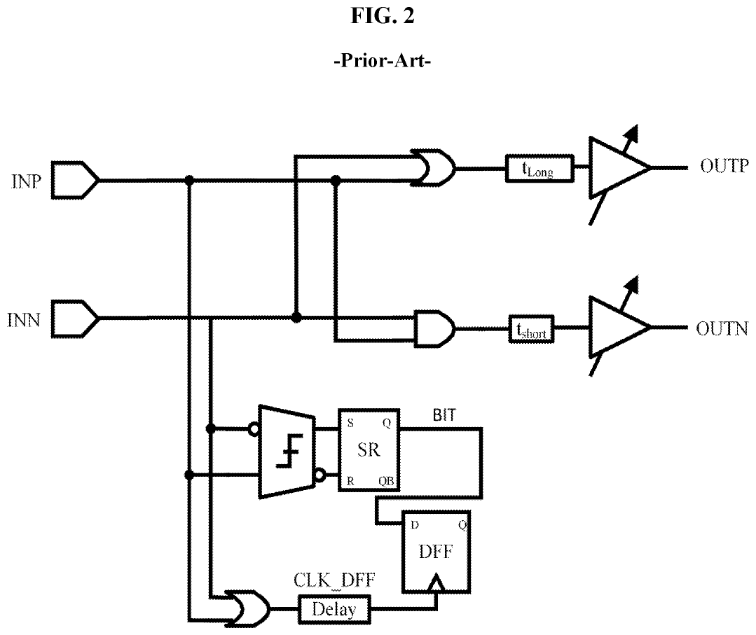

FIG. 1 is a diagram illustrating a SAR TDC circuit according to the prior art. FIG. 2 is a diagram illustrating a SAR TDC circuit according to the prior art, which is an improvement over FIG. 1.

A conventional time-to-digital converter (TDC) is a circuit that detects a time difference (phase difference) between input signals and converts the same into a digital code.

Depending on the conversion method and circuit structure, a successive approximation register time-to-digital converter (SAR TDC), a Vernier time-to-digital converter (Vernier TDC), a pipeline time-to-digital converter (Pipeline TDC), and the like may be used.

As shown in FIG. 1, a successive approximation register time-to-digital converter (SAR TDC) is one of the most representative time-to-digital converters (TDCs) related thereto.

Referring to FIG. 1, a successive approximation register time-to-digital converter (SAR TDC) according to the prior art is a circuit that converts a time difference into a digital code using a binary search method.

In the conventional successive approximation register time-to-digital converter (SAR TDC), each of a plurality of input pulses (INP, INN) passes through two delay lines (TLong, Tshort), thereby producing a total of four signals. At the same time, the comparator compares the plurality of input pulses (INP, INN), determines two signals to be used as signals of a multiplexer (MUX), and outputs a quantization bit.

The determined two signals are used as input signals of the multiplexer (MUX) and select delay lines. At this time, among the plurality of input pulses (INP, INN), an input pulse having an earlier arrival time is output through the multiplexer (MUX) with the delay line (TLong) selected, and an input pulse having a later arrival time is output through the multiplexer (MUX) with the delay line (Tshort) selected.

In the conventional successive approximation register time-to-digital converter (SAR TDC), the plurality of input pulses (INP, INN) are operated such that, after passing through the two delay lines (TLong, Tshort) respectively included therein, the pulses are selected by the multiplexer (MUX).

As a result, although only two delay lines out of a total of four delay lines are selected and used, there is a problem in that all four delay lines must be calibrated when an error occurs because the input pulses are applied to all of the delay lines. There is also a problem in that power consumption is high because even unnecessary delay lines are used.

To solve this problem, as shown in FIG. 2, an AND/OR gate-based SAR TDC has been developed.

Referring to FIG. 2, the AND/OR gate-based SAR TDC is a successive approximation register time-to-digital converter (SAR TDC) improved over that of FIG. 1, and is a circuit that solves the problems occurring in FIG. 1 by using only two delay lines.

The plurality of input pulses (INP, INN) are operated to be output by delay lines (TLong, Tshort) after passing through an AND gate and an OR gate.

Here, due to structural differences between the AND gate and the OR gate, a delay occurs between the gates, and, in addition, an output of the comparator may not coincide with outputs of the AND gate and the OR gate due to an offset of the comparator.

As a result, an additional circuit for calibrating an error between the gates is required, thereby increasing conversion time and reducing power efficiency.

Accordingly, there is a need for a time-to-digital converter (TDC) capable of minimizing delay lines, operating at high speed, and increasing power efficiency at the same time.

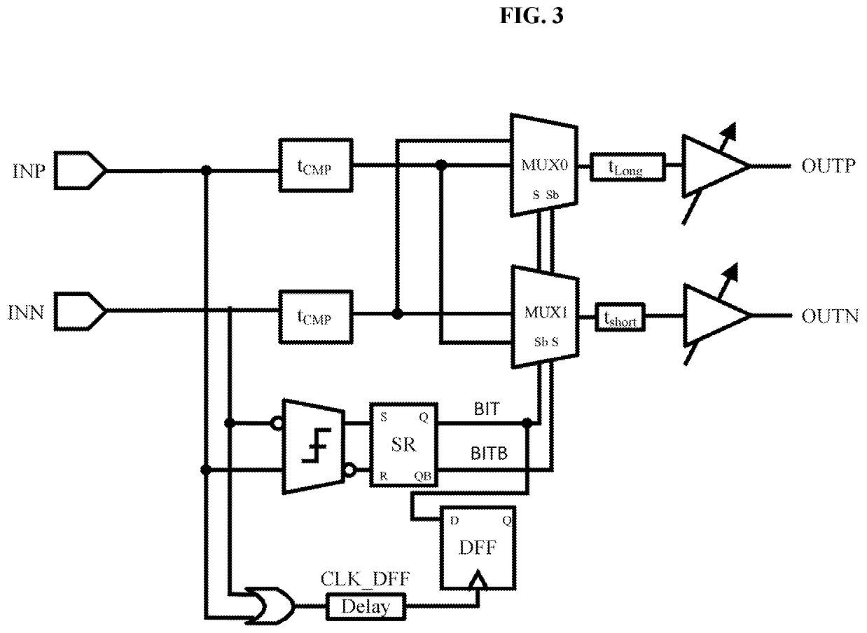

FIG. 3 is a diagram illustrating a SAR TDC circuit according to one embodiment of the present disclosure.

Referring to FIG. 3, the successive approximation register time-to-digital converter (SAR TDC) according to one embodiment of the present disclosure may include a comparator for comparing a plurality of input pulses (INP, INN), a first multiplexer (MUX0), a second multiplexer (MUX1), a first delay line (TLong), and a second delay line (Tshort).

More specifically, the successive approximation register time-to-digital converter (SAR TDC) according to one embodiment of the present disclosure may receive, at the comparator, a plurality of input pulses including a first input pulse (INP) and a second input pulse (INN), and may operate to compare arrival times of the first input pulse (INP) and the second input pulse (INN).

Here, the comparator may compare arrival times of the plurality of input pulses (INP, INN) and output a binary bit of 0 or 1, and the comparator may be configured as a time comparator.

The successive approximation register time-to-digital converter may further include an SR latch receiving the output of the comparator.

Here, the SR latch may store the output value of the comparator through a set (SET) signal or a reset (RESET) signal at the moment when the output of the comparator changes, thereby preventing malfunction of the successive approximation register time-to-digital converter (SAR TDC), and may improve reliability of the SAR TDC by preventing an unstable state of the comparator output in advance.

The successive approximation register time-to-digital converter (SAR TDC) according to one embodiment of the present disclosure may further include a first multiplexer (MUX0) and a second multiplexer (MUX1) configured to receive the plurality of input pulses including the first input pulse (INP) and the second input pulse (INN).

The successive approximation register time-to-digital converter (SAR TDC) according to one embodiment of the present disclosure may further include a first delay line (TLong) connected to the first multiplexer (MUX0) and a second delay line (Tshort) connected to the second multiplexer (MUX1).

At this time, an output signal of the comparator may be used as an input signal of the multiplexers (MUX0, MUX1) that determine the delay lines (TLong, Tshort).

The first multiplexer (MUX0) and the second multiplexer (MUX1) of the successive approximation register time-to-digital converter (SAR TDC) according to one embodiment of the present disclosure may determine, based on the comparison result of the comparator, to which delay line the first input pulse (INP) or the second input pulse (INN) is to be transmitted.

Thereby, the successive approximation register time-to-digital converter (SAR TDC) according to one embodiment of the present disclosure can solve the problem, occurring in the AND/OR gate-based SAR TDC shown in FIG. 2, that the comparator output does not match the AND/OR gate output.

The successive approximation register time-to-digital converter (SAR TDC) according to one embodiment of the present disclosure may further include a D flip-flop.

Here, the D flip-flop may receive the first input pulse (INP) and the second input pulse (INN), determine and store arrival times of the plurality of input pulses (INP, INN), and supply a stable comparator output to the first multiplexer (MUX0) and the second multiplexer (MUX1).

The first multiplexer (MUX0) may determine to transmit, to the first delay line (TLong), an input pulse having an earlier arrival time among the first input pulse (INP) and the second input pulse (INN).

The second multiplexer (MUX1) may determine to transmit, to the second delay line (Tshort), an input pulse having a later arrival time among the first input pulse (INP) and the second input pulse (INN).

More specifically, the first delay line (TLong) of the successive approximation register time-to-digital converter (SAR TDC) according to one embodiment of the present disclosure may hold an input pulse input to the first delay line (TLong) until one of the first input pulse (INP) and the second input pulse (INN) is input to the second delay line (Tshort).

At this time, when one of the first input pulse (INP) and the second input pulse (INN) is input to the second delay line (Tshort), the first delay line (TLong) may output an output signal.

The second delay line (Tshort) may output an output signal in synchronization with the output signal of the first delay line (TLong).

The successive approximation register time-to-digital converter (SAR TDC) according to one embodiment of the present disclosure may further include a comparator delay line (Tcmp) configured to receive the plurality of input pulses including the first input pulse (INP) and the second input pulse (INN) and hold the plurality of input pulses while the comparator operates.

At this time, the comparator delay line (Tcmp) may be composed of a third delay line and a fourth delay line.

The third delay line may receive the first input pulse (INP) and may operate to transmit the first input pulse (INP) to one of the first multiplexer (MUX0) and the second multiplexer (MUX1).

The fourth delay line may receive the second input pulse (INN) and may operate to transmit the second input pulse (INN) to one of the first multiplexer (MUX0) and the second multiplexer (MUX1).

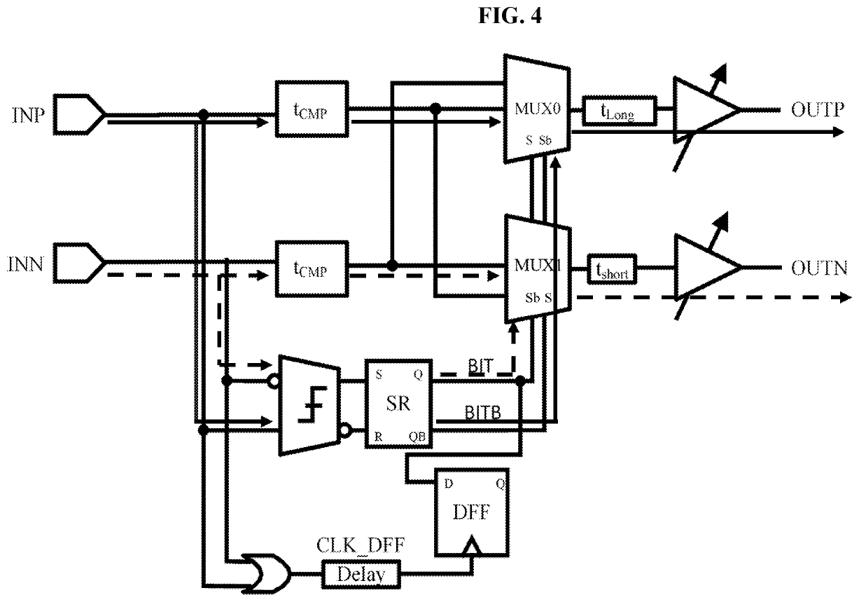

FIGS. 4 to 7 are diagrams illustrating operations of input pulses according to arrival times in the SAR TDC circuit according to one embodiment of the present disclosure.

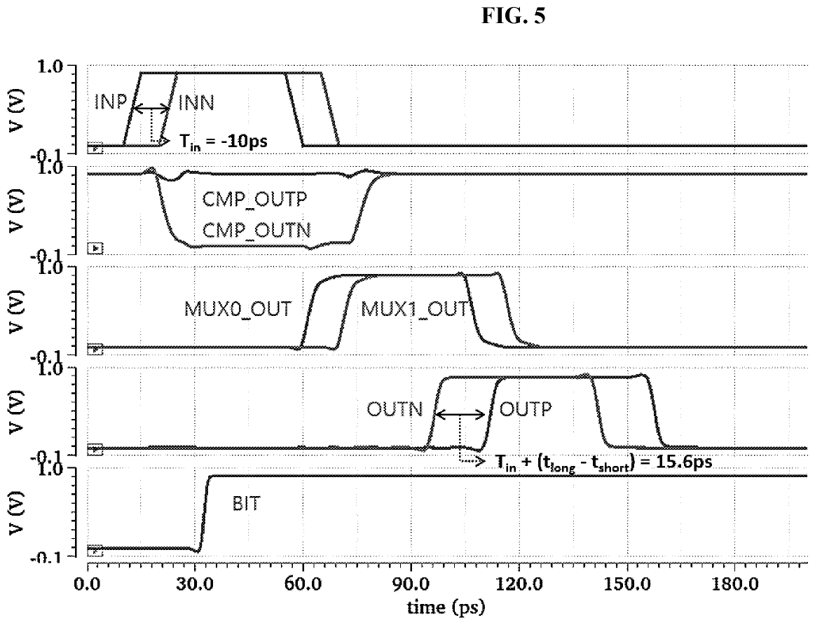

FIG. 4 is a diagram illustrating an operation of the SAR TDC circuit according to one embodiment of the present disclosure when an INP pulse arrives first, and FIG. 5 is a diagram illustrating a simulation result of the operation of FIG. 4.

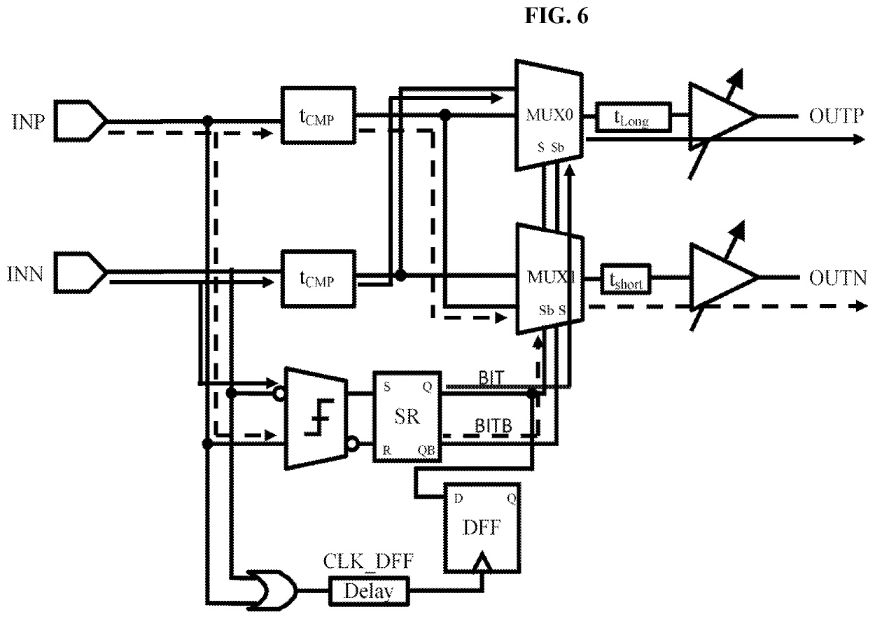

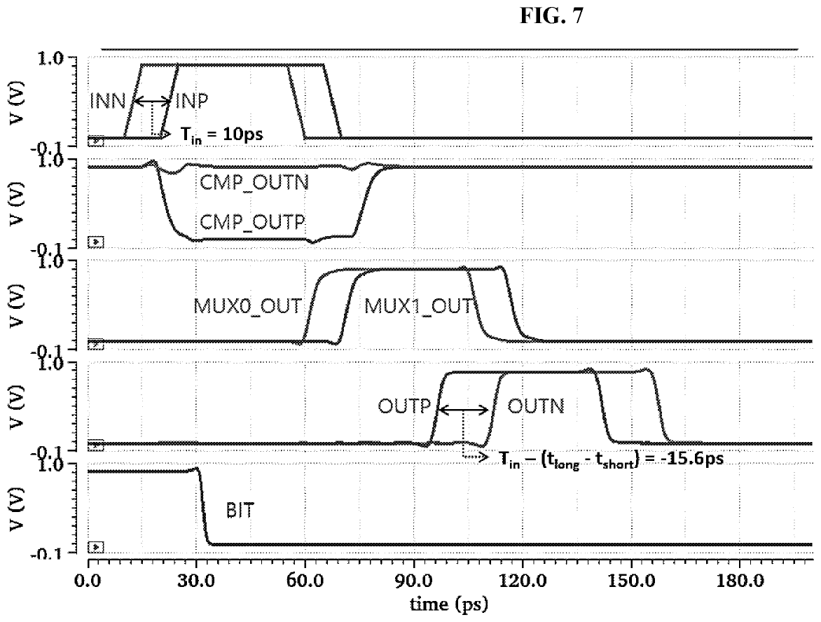

FIG. 6 is a diagram illustrating an operation of the SAR TDC circuit according to one embodiment of the present disclosure when an INN pulse arrives first, and FIG. 7 is a diagram illustrating a simulation result of the operation of FIG. 6.

More specifically, referring to FIGS. 4 and 5, when the first input pulse (INP) arrives first in the successive approximation register time-to-digital converter (SAR TDC) according to one embodiment of the present disclosure, the comparator outputs “1” for the first input pulse (INP) and outputs “0” for the second input pulse (INN).

At this time, for the first input pulse (INP), which arrives early, the first delay line (TLong) is selected and output by the first multiplexer (MUX0), and, for the second input pulse (INN), which arrives late, the second delay line (Tshort) is selected and output by the second multiplexer (MUX1).

Further, referring to FIGS. 6 and 7, when the second input pulse (INN) arrives first in the successive approximation register time-to-digital converter (SAR TDC) according to one embodiment of the present disclosure, the comparator outputs “0” for the first input pulse (INP) and outputs “1” for the second input pulse (INN).

At this time, for the first input pulse (INP), which arrives late, the second delay line (Tshort) is selected and output by the second multiplexer (MUX1), and, for the second input pulse (INN), which arrives early, the first delay line (TLong) is selected and output by the first multiplexer (MUX0).

Accordingly, an input pulse arriving early causes the comparator to output “1”, and an input pulse arriving late causes the comparator to output “0”. The first multiplexer (MUX0) passes the early-arriving input pulse and transmits the same to the first delay line (TLong), while the second multiplexer (MUX1) passes the late-arriving input pulse and transmits the same to the second delay line (Tshort) so as to be output.

At this time, when the plurality of input pulses become “0” and the comparator outputs “1”, the comparator is reset (RESET) and is placed in a state capable of receiving a next input pulse.

The simulation was verified with a rising-edge time difference between the plurality of input pulses (INP, INN) set to 10 ps, and the simulation result showed that a difference between the first delay line (TLong) and the second delay line (Tshort) was 25.6 ps.

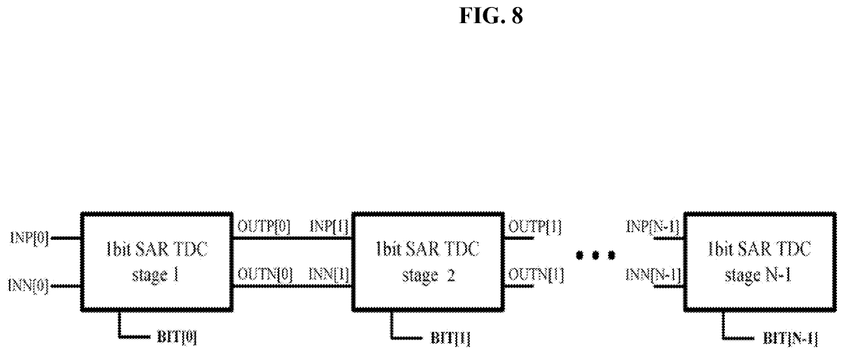

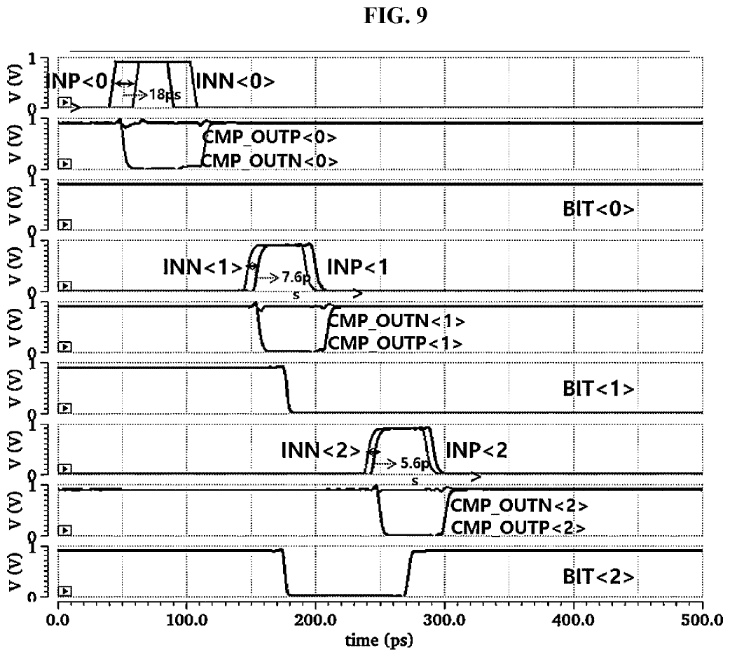

FIG. 8 is a diagram illustrating a SAR TDC circuit composed of a plurality of bits according to one embodiment of the present disclosure, and FIG. 9 is a diagram illustrating a simulation result of the operation of FIG. 8.

Referring to FIGS. 8 and 9, the successive approximation register time-to-digital converter (SAR TDC) according to one embodiment of the present disclosure may operate with a plurality of data bits.

More specifically, the successive approximation register time-to-digital converter (SAR TDC) according to one embodiment of the present disclosure may be configured as an N-bit SAR TDC and may operate in a cascaded manner. When operation of a 1-bit stage is completed, subsequent operations of a 2-bit stage, a 3-bit stage, . . . , and an N-bit stage may operate by receiving an output signal of an N-1-bit stage as an input pulse.

At this time, each of the plurality of data bit lines may be configured and operate in the same manner as the successive approximation register time-to-digital converter (SAR TDC) according to the embodiment of the present disclosure shown in FIG. 3.

Further, a delay of each bit stage may be defined by Equation (1) below.

TLong−Tshort=2\hat{ }(N−1−n)*LSB Equation (1)
where N=number of bits and n=0, 1, . . . , N-1.

For example, when the successive approximation register time-to-digital converter (SAR TDC) according to one embodiment of the present disclosure is configured as a 3-bit SAR TDC and delays of respective bit stages are 25.6 ps, 12.8 ps, and 6.4 ps, operation may proceed as follows.

More specifically, in the 3-bit SAR TDC, when INP<0> arrives earlier than INN<0> at a first stage, the difference in rising-edge time is 18 ps. The comparator outputs “1” for the INP<0> input pulse and “0” for INN<0>, such that INP<0> is output to the first delay line (TLong) by the first multiplexer (MUX0), and INN<0> is output to the second delay line (Tshort) by the second multiplexer (MUX1) and used as an input value of the next bit stage.

The rising-edge time difference of a second stage is determined to be −7.6 ps by Equation (2) below.

TN+Tshort1−(TP+TLong1) Equation (2)

At this time, INN<1> arrives earlier than INP<1>, such that INN<1> is output to the first delay line (TLong) by the first multiplexer (MUX0), and INP<1> is output to the second delay line (Tshort) by the second multiplexer (MUX1).

Finally, the rising-edge time difference of a third stage is determined to be 5.2 ps by Equation (3) below.

TN+Tshort1+TLong2−(TP+TLong1+Tshort2) Equation (3)

At this time, because INP<1> and INN<1> pass through the multiplexers in opposite directions at the second stage, an output value of INN<1> becomes an input value of INP<2>, and an output value of INP<1> becomes an input value of INN<2>. Consequently, INP<2> is output to the first delay line (TLong), and INN<2> is output to the second delay line (Tshort).

In the successive approximation register time-to-digital converter (SAR TDC) according to one embodiment of the present disclosure, because the multiplexer (MUX) receives the input pulse before the delay line and the delay line is selected and output by the multiplexer (MUX), fewer delay lines are used than in the prior art. Therefore, correction of errors occurring in the delay lines can be facilitated, and power consumption can also be reduced.

Further, because the output signal of the comparator is used as the input signal of the multiplexer (MUX), data distortion can be suppressed.

The apparatus described above may be implemented by hardware components, software components, and/or a combination of hardware components and software components. For example, devices and components described in the embodiments may be implemented using one or more general-purpose computers or special-purpose computers, such as processors, controllers, arithmetic logic units (ALUs), digital signal processors (DSPs), microcomputers, field programmable arrays (FPAs), programmable logic units (PLUs), microprocessors, or any other device capable of executing instructions and responding thereto. A processing device may execute an operating system (OS) and one or more software applications executed on the operating system. The processing device may also access, store, manipulate, process, and generate data in response to execution of software. For convenience of understanding, although a single processing device may be described as being used, one of ordinary skill in the art will appreciate that the processing device may include a plurality of processing elements and/or a plurality of types of processing elements. For example, the processing device may include a plurality of processors, or a single processor and a single controller. Other processing configurations, such as a parallel processor, are also possible.

Software may include a computer program, code, instructions, or one or more combinations thereof, and may configure a processing device to operate as desired or may independently or collectively instruct the processing device. Software and/or data may be embodied in any type of machine, component, physical device, virtual equipment, computer storage medium, or device, to be interpreted by the processing device or to provide instructions or data to the processing device. Software may be distributed over network-connected computer systems and may be stored or executed in a distributed manner. Software and data may be stored on one or more computer-readable recording media.

Methods according to embodiments may be embodied in the form of program instructions that can be executed through various computer means and recorded on a computer-readable medium. The computer-readable medium may include program instructions, data files, data structures, or combinations thereof, alone or in combination. Program instructions recorded on the medium may be specially designed and configured for the embodiments, or may be known and available to those skilled in the computer software art. Examples of computer-readable recording media include magnetic media such as hard disks, floppy disks, and magnetic tape; optical recording media such as CD-ROMs and DVDs; magneto-optical media such as floptical disks; and hardware devices specially configured to store and execute program instructions, such as ROM, RAM, and flash memory. Examples of program instructions include machine language code such as that produced by a compiler, as well as high-level language code executable by a computer using an interpreter or the like.

Although embodiments have been described above with reference to limited embodiments and drawings, those skilled in the art may make various modifications and changes from the foregoing description. For example, appropriate results may be achieved even if the described techniques are performed in a different order from the described method and/or components of the described system, structure, device, circuit, and the like are combined or assembled in a different form from the described method, or are replaced or substituted by other components or equivalents. Therefore, other implementations, other embodiments, and equivalents to the claims also fall within the scope of the claims set forth below.

What is claimed is:

1. A successive approximation register time-to-digital converter, comprising:
a comparator configured to receive a plurality of input pulses including a first input pulse and a second input pulse, and to compare arrival times of the first input pulse and the second input pulse;
a first multiplexer configured to receive the plurality of input pulses;
a second multiplexer configured to receive the plurality of input pulses;
a first delay line connected to the first multiplexer; and
a second delay line connected to the second multiplexer.

2. The successive approximation register time-to-digital converter of claim 1,
wherein the first multiplexer and the second multiplexer are configured, based on a comparison result of the comparator, to determine whether the first input pulse and the second input pulse are to be transmitted through the first delay line or the second delay line.

3. The successive approximation register time-to-digital converter of claim 2,
wherein the first multiplexer is configured to route, to the first delay line, one of the first input pulse and the second input pulse having an earlier arrival time.

4. The successive approximation register time-to-digital converter of claim 2,
wherein the second multiplexer is configured to route, to the second delay line, one of the first input pulse and the second input pulse having a later arrival time.

5. The successive approximation register time-to-digital converter of claim 1,
wherein the first delay line is configured to hold an input pulse received by the first delay line until one of the plurality of input pulses is input to the second delay line.

6. The successive approximation register time-to-digital converter of claim 1,
wherein the second delay line is configured to output an output signal of the second delay line in synchronization with an output signal of the first delay line.

7. The successive approximation register time-to-digital converter of claim 1,
further comprising a comparator delay line configured to receive the plurality of input pulses and to hold the plurality of input pulses for an operating time of the comparator.

8. The successive approximation register time-to-digital converter of claim 7,
wherein the comparator delay line includes a third delay line configured to receive the first input pulse and to transmit the first input pulse to one of the first multiplexer and the second multiplexer.

9. The successive approximation register time-to-digital converter of claim 7,
wherein the comparator delay line includes a fourth delay line configured to receive the second input pulse and to transmit the second input pulse to one of the first multiplexer and the second multiplexer.

10. A successive approximation register time-to-digital converter, comprising:
a comparator configured to receive a plurality of input pulses including a first input pulse and a second input pulse, and to compare arrival times of the first input pulse and the second input pulse;
a first multiplexer configured to receive the plurality of input pulses;
a second multiplexer configured to receive the plurality of input pulses;
a first delay line connected to the first multiplexer;
a second delay line connected to the second multiplexer; and
a comparator delay line configured to receive the plurality of input pulses and to hold the plurality of input pulses for an operating time of the comparator.

11. The successive approximation register time-to-digital converter of claim 10,
wherein the first multiplexer is configured to route, to the first delay line, one of the first input pulse and the second input pulse having an earlier arrival time.

12. The successive approximation register time-to-digital converter of claim 10,
wherein the second multiplexer is configured to route, to the second delay line, one of the plurality of input pulses having a later arrival time.

13. The successive approximation register time-to-digital converter of claim 10,
wherein the first delay line is configured to hold an input pulse received by the first delay line until one of the plurality of input pulses is input to the second delay line.

14. The successive approximation register time-to-digital converter of claim 10,
wherein the second delay line is configured to output an output signal of the second delay line in synchronization with an output signal of the first delay line.

15. A successive approximation register time-to-digital converter comprising a plurality of data bit lines, wherein each of the plurality of data bit lines comprises:
a comparator configured to receive a plurality of input pulses including a first input pulse and a second input pulse, and to compare arrival times of the first input pulse and the second input pulse;
a first multiplexer configured to receive the plurality of input pulses;
a second multiplexer configured to receive the plurality of input pulses;
a first delay line connected to the first multiplexer; and
a second delay line connected to the second multiplexer.
